(19) United States
(12) Patent Application Publication
(10) Pub. No.: US 2007/0279627 A1
(43) Pub. Date: Dec. 6, 2007

(54) Raman instrumentation

(76) Inventors: Leslie M. Tack, San Francisco, CA (US); Bruce True, Santa Clara, CA (US)

Correspondence Address: STANLEY Z COLE, 26620 ST FRANCIS ROAD, LOS ALTOS HILLS, CA, 94022, US

(21) Appl. No.: 11/445,638

(22) Filed: Jun. 2, 2006

(51) Int. Cl. G01J 3/44; G01N 21/65

(52) U.S. Cl. 356/301

(57) ABSTRACT

A portable Raman spectroscopy instrument capable of discriminating between chemicals in the solid, liquid and vapor states is described. The instrument is in the shape of a gun and uses a solid state detector and an NIR laser. It relies on gating techniques to minimize weight and lower energy needs.

### FIELD OF THE INVENTION

This invention relates to the field of instrumentation and more particularly to industrial and portable Raman spectrometers and spectroscopy. Raman instruments can be used to analyze chemicals in the solid, liquid, or vapor phases.

### BACKGROUND OF INVENTION

Raman spectroscopy is a spectroscopic technique used in branches of physics and chemistry to study vibrational, rotational, and other low-frequency modes in a system. It relies on inelastic scattering, or Raman scattering of monochromatic light, usually from a laser in the visible, near infrared, or near ultraviolet range. Photons or other excitations in the system are absorbed or emitted by the laser light, resulting in the energy of the laser photons being shifted up or down. Infrared spectroscopy yields similar, but complementary information.

Typically, a sample is illuminated with a laser beam (see FIG. 2). Light from the illuminated spot is collected with a lens and sent through a monochromator. Wavelengths close to the laser line (due to elastic Rayleigh scattering) are filtered out and those in a certain spectral window away from the laser line are dispersed onto a detector.

Spontaneous Raman scattering is typically very weak, and as a result the main difficulty of Raman spectroscopy is separating the weak inelastically scattered light from the intense Rayleigh scattered laser light. Raman spectrometers typically use holographic diffraction gratings and multiple dispersion stages to achieve a high degree of laser rejection. A photon-counting photomultiplier tube (PMT) was a popular detector for Raman in the 1960's and 1970's. The availability of linear and two dimensional scientific CCD's in the 1980's energized dispersive Raman spectroscopy by allowing wider spectral coverage with much shorter observation times relative to PMT's. Because of the limitations of the spectral response for PMT's and CCD's, most Raman applications were limited to the spectral band of 400 to 1000 nm, with common laser excitation wavelengths at visible wavelengths. The main drawback of visible wavelengths is that they induced sample fluorescence which obscured the weak Raman signals. Clearly, there was a need to resolve the fluorescence issue, and that meant shifting Raman spectrometers over to longer wavelengths with laser excitation >1000 nm, and employing spectrometers capable of high resolution and spectral coverage between 1000 and 1500 nm.

The subsequent invention and commercialization of the FT-Raman spectrometer (Fourier Transform Raman Spectrometer) in the 1980's was the first solution to provide “fluorescent free” Raman spectra. In this instrument, a Nd:YAG laser (flash lamp pumped solid state laser emitting at 1064 nm) was used to excite the sample, and the resulting Raman signal was detected using an interferometer with a single element detector. This resulted in a much superior Raman signal in a shorter acquisition time due to the multiplex effect. In addition, the use of a near-IR laser resulted in complete elimination of fluorescence in most samples and a significant reduction of fluorescence in all samples. (Chase, D. Bruce., “Fourier transform Raman spectroscopy”, Journal of the American Chemical Society, Volume 108, 1986, pages 7485-8). These instruments were rapidly adopted by both academia and industry (Cooper, John B.; Wise, Kent L.; Groves, J., “Determination of octane numbers and Reid vapor pressure of commercial petroleum fuels using FT-Raman spectroscopy and partial least-squares regression analysis”, Analytical Chemistry, Volume 67, 1995, pages 4096-100; Cooper; John B, Bledsoe, Jr.; Roy R, Wise; Kent L., Sumner; Michael B, Welch; William T, Wilt; Brian K, U.S. Pat. No. 5,892,228: Process and apparatus for octane numbers and reid vapor pressure by Raman spectroscopy, Apr. 6, 1999; Cooper; John B., Flecher, Jr.; Philip E., Welch; William T. , U.S. Pat. No. 10 5,684,580: Hydrocarbon analysis and control by Raman spectroscopy, Nov. 4, 1997; Cooper; John B., Wise; Kent L., Welch; William T., Sumner; Michael B., U.S. Pat. No. 5,596,196: Oxygenate analysis and control by Raman spectroscopy, Jan. 21, 1997; Cooper, John B, Wise, Kent L., Bledsoe, Roger R., “Comparison of Near-IR, Raman, and 15 Mid-IR Spectroscopies for the Determination of BTEX in Petroleum Fuels”, Applied Spectroscopy, Volume 51, 1997, pages 1613-16). To date there have been numerous improvements on the original design including improvements in detectors, interferometers, and lasers (Chase, 20 Bruce., “Fourier transform Raman spectroscopy”, Analytical Chemistry, Volume 59, 1987, pages 881A-2A; Asselin, Kelly J, Chase, B., “FT-Raman Spectroscopy at 1.339 Micrometers”, Applied Spectroscopy, Volume 8, 1994, pages 699-704; Burch; Robert V., U.S. Pat. No. 5,247,343: 25 Raman spectrometer having optical subtraction filters, Sep. 21, 1993).

FT-Raman instruments are an elegant solution to broadband Raman spectroscopy but they have serious drawbacks for industrial and field applications:
They are very sensitive to vibrations and are quite fragile overall.
They are very heavy and power consumptive.
They are expensive to buy and have high cost of ownership.

Recent parallel advances in the development of high performance lasers, sensors, spectrometers, optical probes, and computers have led to the appearance of portable, and hand-held units starting in the late 1990's. More recent advances in laser and spectrometer miniaturization have led to service applications in the life science and telecommunications markets, are paving the way for the next generation of hand-held Raman products.

Raman, as practiced in accordance with this invention, is ideal for field chemical substance identification and the technology maps very well to “on the run” applications in forensics, homeland security, pharmaceuticals, food analysis, and the military. The new millennium and recent world events have accelerated the migration of analytical instrumentation from the laboratory to the field. The described Raman gun, because of its combination of rugged design and high performance will have expanded use overall, with field and 24×7 applications driving its growth.

The general approach taken for Raman spectrometer design for industrial applications has been to start with a working laboratory system and attempt to make it as compact as possible.

Many common features of these systems include:
High powered CW lasers ˜785 nm
Deeply cooled spectroscopy CCD's
High power consumption because of deep cooling and high laser power needs
Raman coverage ˜+300 to +2200 cm⁻¹
Requires external computer.

Systems also are configured with relatively outdated lasers, spectrometers, sensors and computer technology with the result that equipment is expensive, has a large footprint, and has high power consumption levels. These factors also make existing systems difficult to use for field applications.

### SUMMARY OF THE INVENTION

There is described, a compact novel Raman instrument. It is discussed as shaped like a small gun. The instrument has low power consumption. It is convenient to handle and store, making it ideal for field chemical substance identification. The Raman gun disclosed, because of its rugged design and high performance capabilities, offers a real tool for such field applications. Additionally, although the gun fits this particular niche well, it is not limited to such an application but may also be used for any application where Raman readings are desired.

The Raman gun uses a laser. Associated with the laser are optical elements to deliver the laser energy to the sample. Laser energy which is reflected, scattered, and ‘Raman shifted’ is re-radiated from the sample. Collection optics gather the re-radiated energy and deliver it to an optical fiber. Energy propagates through the fiber and is projected into a spectrometer. The spectrometer generates the spectral data that is then processed inside an embedded signal/data processor. Data processing results in a list of suspect materials that may be present in the sample.

The described system makes use of a highly efficient detector. The detector uses electron bombardment to obtain gain. It also has a light sensitive element that has high spectral responsivity to wavelengths in the 950 to 1650 nm range. In its preferred embodiment, it includes a two dimensional array in which each pixel yields an electrical response that is proportional to the Stokes Raman scattering at a particular wavelength as to permit the creation of a Stokes Raman spectrum of the sample. Thus the laser selected for the gun will operate in this range of near-infrared wavelengths. This results in a detector that is substantially blind to and insensitive to UV and/or visible light. The laser used in the system should be highly stable and monochromatic and is selected to emit light in a selected wavelength between 920 to 1550 nm. The light sensitive element acts as a blocking filter to the extent that the range of the laser is beyond the responsivity of the light sensitive element.

When the term “two dimensional array” is used in this description and in the claims there is meant sensors with pixels along two axes (e.g., 512×512). The depth of the pixel does not enter into this description. Also when “two dimensional electron bombarded (EB) sensors” is used this is intended to mean any silicon focal plane array such as CMOS, CCD's, CCD/CMOS hybrids or CCD's with on-chip gain, also known as EM-CCD's. The term CMOS for example (or any of the focal plane arrays) implies a focal plane array without a photocathode. As used in the systems discussed, this element acts as an anode in a circuit and for this reason may be referred to as the anode. If a photocathode is combined with a CMOS (or other focal plane array) this would be a sensor and would typically be a sensor including electron bombardment or an EBCMOS. In such a case the CMOS is bombarded by electrons during exposure of the related photocathode for example. The wod detector is also used interchangeably with the word sensor.

Retuning now to the description, it is possible to operate the detector or sensor in a gated fashion without reducing the quality of the detectors response. Gating enables a reduction in power for the gun and at the same time provides insulation against background light and noise.

Power consumption is considerably reduced through the detector's high (NIR) sensitivity, high electronic gain, and by limiting laser utilization through use of the inherent triggering and gating capabilities of the detector. Additionally, as compared to deeply cooled CCD's, the sensor only requires temperature stabilization to room temperature, further reducing the power requirements of the complete system.

In summary, the Raman gun provides exceptional near-infrared sensitivity along with unique capabilities for portable high quality low energy applications. It includes a source of optical energy (e.g. a laser), which is used to irradiate/stimulate a sample. The laser operates at a wavelength within a broad area of the near-infrared wavelengths. Associated with the laser are optical elements used to deliver the laser energy to the sample. Laser energy which is reflected, scattered, and ‘Raman shifted’ is re-radiated from the sample. Collection optics gather the re-radiated energy and deliver it to an optical fiber. The energy propagates through the fiber and is projected into a spectrometer. The spectrometer generates the spectral signals that are then delivered to the detector, digitized, and finally processed inside an embedded signal/data processor. The detector has a particular sensitivity to the Raman shifted signals. The results of the data processing identifies materials that are present in the sample, and this information is displayed on the LCD display surface of the gun.

These and other aspects of this invention will become evident upon reference to the following drawings and associated description. However, it should be clear, that various changes, additions and/or subtractions, can be made in the disclosed system and its methods without departing from the spirit or scope of the described invention.

### BRIEF DESCRIPTION OF THE DRAWINGS

FIG. 1 illustrates the Raman effect.

FIG. 2 is a schematic illustration of a Raman gun in accordance with this invention. The outer wall is illustrated as a transparent cover.

FIG. 3 is a schematic illustration of the process of Raman spectroscopy as conducted in accordance with this invention using the Raman gun illustrated in FIG. 2.

FIG. 4 is a schematic illustration of the back wall of the Raman gun of FIG. 3.

FIG. 5 is a schematic illustration of the detector portion of the gun.

FIG. 6 is a timing diagram explaining the operational sequences.

FIG. 7 is a set of responsivity curves.

### DETAILED DESCRIPTION OF A PREFERRED EXEMPLARY EMBODIMENT

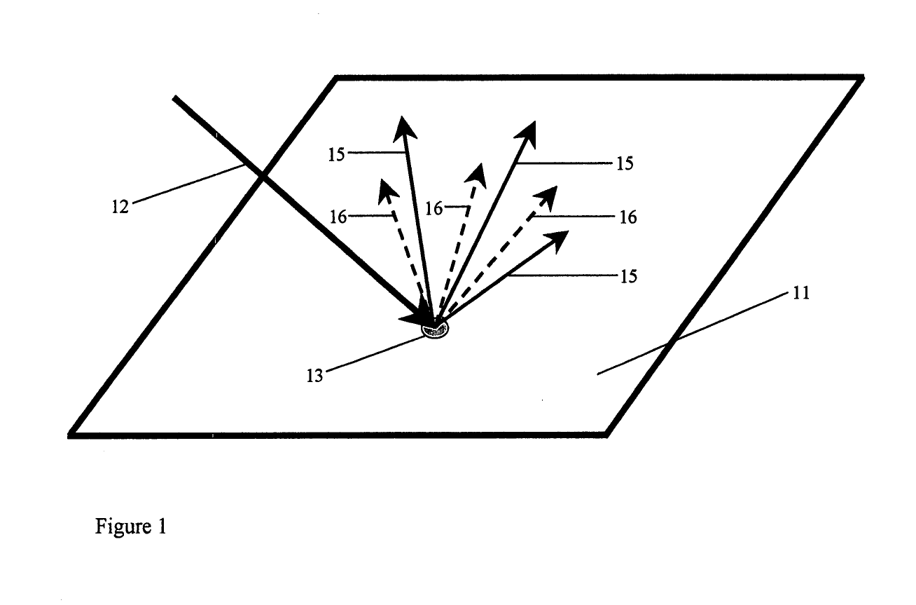

Referring now to FIG. 1, there is shown a sample 11 and an incoming incident light beam 12 that is directed to spot 13 on sample 11. Irradiating outward from spot 13 are rays of light 15 and 16. The rays 15 are indicated as continuous lines, and represent in this Figure, scattered light of the same wavelength as the wavelength of the incident light beam 12. This is referred to as Raleigh Scatter. The rays 16, indicated as dashed lines, represent scatter at a different wavelength than the incoming wavelength of the incident light beam 12. The light scattered at different wavelengths 16 is referred to as Raman scatter.

This figure illustrates the Raman effect in its simplest form. It is employed in all Raman instrumentation. It is also a basis to explain principles incorporated into the instrument of this invention. The sample 11 may comprise a material of any chemical substance. The incoming light beam is reflected back in beams that appear at the same wavelength as the incoming beam and at different wavelengths from the incoming beam. The light reflected back at different wavelengths from the incoming beam is captured to yield a spectral signature that, by reference to stored spectral libraries, enables an analysis of the materials in sample 11 in terms its chemical constituents.

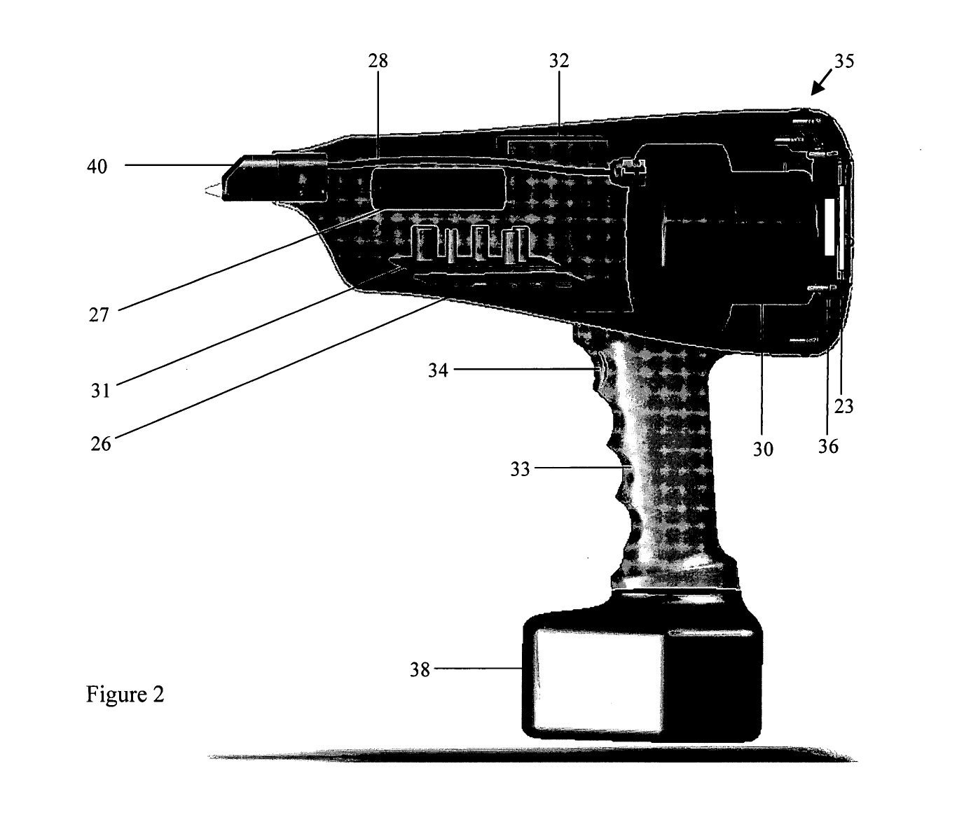

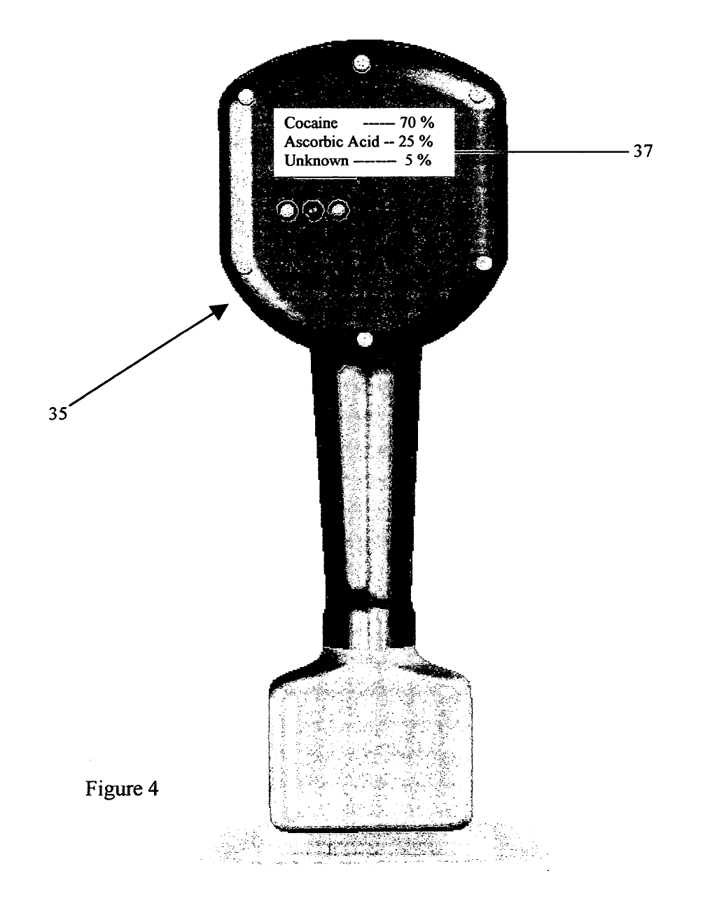

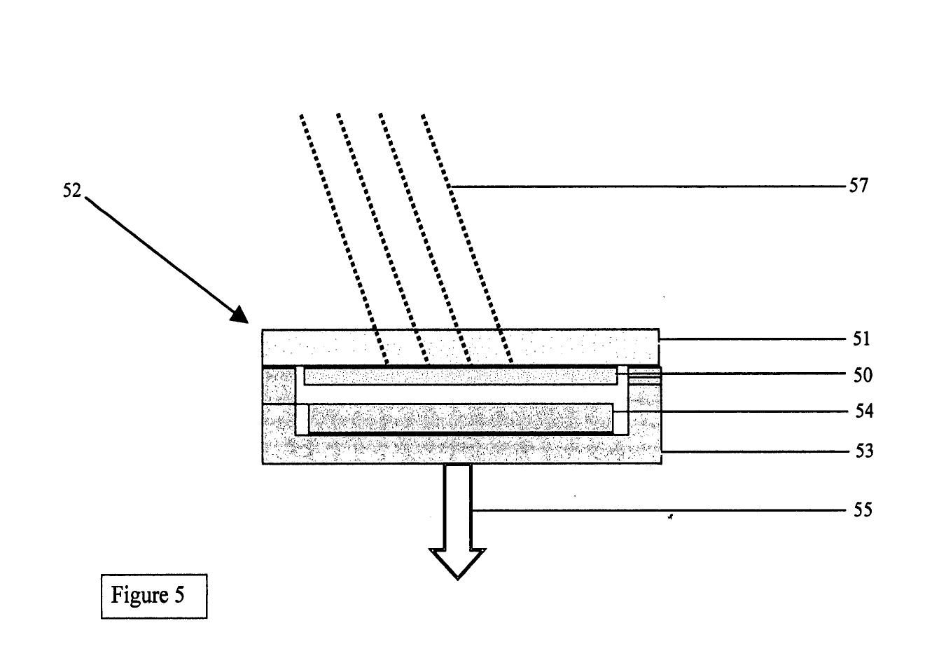

FIG. 2 is a schematic illustration of a compact and portable Raman gun 35 in accordance with this invention. For the purpose of this discussion the outer shell or casing 26 is shown as a transparent material. This has been done in this illustration to facilitate a discussion of the components of the gun encased within the casing, and to show an embodiment positioning the elements. The outer wall is generally made of a lightweight plastic material that provides structural strength, thereby housing the internal components in a protected environment. Within case 26 there is positioned laser 27, fiber optic coupling probe 28, spectrometer 30 and power supply module 31. The laser is a stable light source and emits highly monochromatic light at a selected wavelength between about 920 and 1550 nm. Also, there may be positioned a wireless module 32 within housing 26, as will be described more fully hereinafter. A hand-grip 33 is provided at the base of the unit to provide a convenient way to hold the unit. A trigger switch 34 is at the top of handgrip 33. At the rear of the unit, and behind spectrometer 30 is a detector 36, explained more fully in connection with FIG. 5, a microprocessor 23 and an LCD screen 37, shown in a view of the rear of the gun in FIG. 4.

The illustrated embodiment of Raman gun 35 is a unique combination of components. For example, although lasers have been used in Raman systems, and in other technologies, the lasers typically used in the field of Raman spectroscopy have generally operated at frequencies of 785 nm or less. Such lasers are avoided in this invention since they are relatively heavy. In addition, detectors used with such lasers are generally sensitive to stray light in the 300-1000 nm range. This sensitivity is a problem for field applications of a Raman gun. The use of 785 nm lasers has represented the best effort to minimize fluorescence problems by working at as long a wavelength as possible in these prior art units, while still constrained by the quantum efficiency properties of a silicon detector.

In the present invention, lasers in the range of 950 to 1700 nm and preferably in the range of 920-1500 nm are used. These ranges permit the use of a laser of reasonable weight for a portable unit, and by matching sensitivity in the detector to the Raman-shifted laser wavelengths minimizes the effects of stray light and fluorescence in the system. The preferred detector arrangement in this invention includes the use of a CMOS camera system in conjunction with a photocathode whose sensitivity generally matches that of the Raman-shifted near infrared (NIR) frequencies central to the identifications of suspect chemical materials.

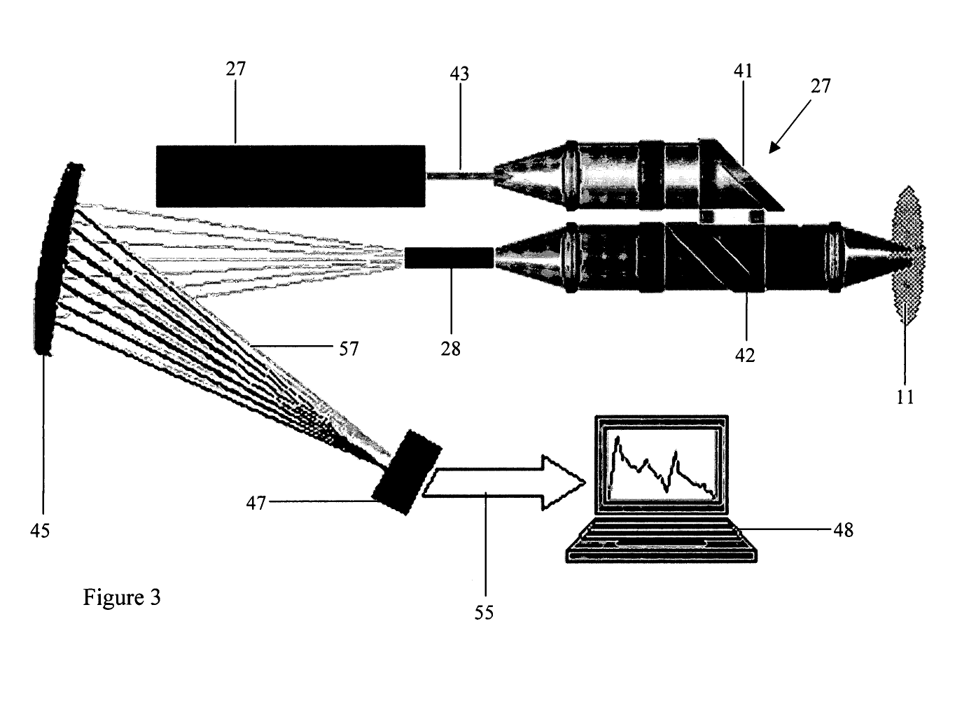

The gun illustrated in FIG. 2 in its preferred embodiment is of a size in which the barrel portion extends outward less than about 12 inches in length. This is mentioned so that one can picture in the mind's eye the size of the entire instrument. Further this size has been selected to facilitate portability. As should be apparent from the discussions herein, the gun could be of a size significantly larger or smaller since this will have little effect on the performance of the system. Thus the barrel could be shorter or longer with items located within the barrel adjusted accordingly without affecting the performance of this invention. Laser 27 is positioned to direct its output beam to optical probe 40 and optical probe 40 is connected to spectrograph 30 via fiber optics 28. Wireless module 32 included in housing 26 may be used to transmit information both out of and into the unit. It can connect to a USB 2.0 connection that in turn may be connected directly to a computer. (This is the embodiment that is shown in FIG. 3.) It may also be used to update firmware and spectral libraries within the gun, and it may also comprise a Bluetooth arrangement for use with the gun. A battery which may comprise a 12 volt rechargeable battery is provided in enclosure 38 at the base of the pistol handle. As should be apparent, the battery may be placed in other locations of the gun. Probe optics 40 are positioned at the output point of gun 35.

In FIG. 3 is shown a spectroscopy system employing the described Raman gun illustrated in connection with FIG. 2. In this Figure, there is also illustrated the elements of the gun in a functional sense. Laser 27 is selected to emit either a continuous wave (CW) or a pulsed beam 43. The beam exits probe optics 40 via bending mirrors 41 and 42 and then strikes sample 11. Laser 27 is selected to operate at a wavelength between 950 and 1700 nm and preferably in the range between 950 to 1500 nm. Mirror 42 which directs the beam out of the gun, also functions as a filter to pass selected Raman scattered light from sample 11, collected by optical probe 40, through to fiber 28, and through fiber 28 to spectrometer 30 (shown in FIG. 2). The spectrometer includes grating 45. As described in connection with FIG. 1, the filter is positioned to remove Rayleigh scattered light that may reach it, while permitting the passage of Stokes scattered light that is present. At the spectrometer a spectrum is created from the incoming light. Grating 45 disperses the light by colors or wavelengths generating spectra for analysis. The light, after passing by grating 45, next strikes detector 36.

Thus in Raman gun 35, part of the overall optical path performs a shared function of delivering the laser energy to the sample, as well as collecting the energy re-radiated from the sample. This shared path is in the forward part of the optical probe optics. Filter 42 within the probe optics enables the separation of the stimulating laser energy from the ‘Raman shifted’ energy which is re-radiated from the sample to pass back into the gun, where it is fed by optics 28 to the spectrometer, and from the spectrometer to detector 36, where identifying signals can be detected.

In FIG. 4 there is shown a rear view of the Raman Gun 35. In this view the LCD read out 37 is in view. The LCD reports the results that are determined by a microprocessor 23 (FIG. 2) in line between the detector and the LCD display. The microprocessor is housed within the casing of gun 35 and compares the input from the sensor to a library of information concerning spectra, and then reports what is present in the sample.

In FIG. 5 there is shown a schematic of the detector. The input to detector 36 is the spectral output from the grating of the spectrometer as shown in FIG. 3. The output of the detector is a signal that appears as a graphical representation on the face of computer 48. At this point one can determine the elements present in the sample by comparing the spectra in the graphical representation to a library of stored information.

The incoming information directed to detector 36 is fed to photocathode 50 through faceplate 51. This faceplate of the detector, which may comprise a glass layer, is transparent to incoming light signals and acts to seal a vacuum 52 within detector 36. The photocathode is selected to be sensitive to incoming Raman scatter, to minimize the effects of stray light in the 300 to 1,000 nm range, and to minimize the effect of fluorescence. Raman scatter in this wavelength is achieved using a laser 27 operating within this wavelength. This proves beneficial since such a laser is generally small and light. Preferably, photocathode 50 comprises a III-V semiconductor transferred electron (TE) photocathode. A TE photocathode comprises a heterojunction structure with a gradually graded alloy or stepwise material changes to form a heterojunction that provides for efficient electron transport between two semiconductor materials. Examples of heterojunction systems appropriate for these applications include InP/InGaAs and InP/InGaAsP.

An electric field is set between imager 54 and the surface of photocathode 46 with the photocathode biased near zero and imager 54 at a high voltage. Photocathode 46 is positioned in proximity focus across a vacuum 52 adjacent to and facing imager 54. On exposure of photocathode 50, electrons are emitted and accelerate to facing layer 54. As a result, semiconductor gain occurs in imager 54 due to the electron bombardment of this layer.

This detector has a small form factor but includes a relatively large image plane. This is beneficial in determining the materials present in the sample. In the preferred embodiment, imager 54 uses electron bombardment of a CMOS chip. The CMOS chip may comprise a die with active pixel sensors and attending circuitry. Electron bombardment results from the release of electrons into the electric field between the photocathode and imager 54. Although such a CMOS imager with active pixel sensors is preferred, one can also use a silicon focal plane array or a CCD imager or a hybrid CCD/CMOS imager in the circuitry prior to the microprocessor 23.

Photocathode 46, when excited or when struck by photons in the wavelength or 950-1500 nm releases electrons spatially in conformance with the input image into the vacuum where they bombard facing imager 54. An appropriate semiconductor photocathode is described in U.S. Pat. No. 5,576,559, incorporated herein by reference. The CMOS sensor chip, spaced across the vacuum facing the photocathode, is also positioned within package 53. The package 53 maintains the photocathode in a spaced relationship to the CMOS imager and seals the vacuum within the device.

The principles of image creation with a CMOS chip and electron multiplication are set forth in U.S. Pat. No. 6,285,018. The photocathode is mounted relative to the vacuum tube anode as set forth in U.S. Pat. No. 6,507,147. It may comprise a photocathode as described in U.S. Pat. No. 5,047,821 or it may comprise any of the other photocathodes described, for example, in U.S. Pat. No. 6,285,018. The output of the CMOS device provides signals to create an output image.

In operation, a low bias is applied to the photocathode and a high voltage is applied to the CMOS imager 52. The photocathode releases electrons on being struck by the incoming light signals. These electrons are released in proportion to the intensity of the incoming light. The electric field across the vacuum drives the released electrons directly to the imager across the vacuum where they bombard the pixels, for example, of a CMOS chip 52, thereby multiplying their effect within the CMOS chip. The pixel array of the CMOS imager, which is controlled by generally known electronics including analog control circuitry and analog to digital converters, feeds an output signal as shown by arrow 55 for processing into a viewable image at computer 48 (see FIG. 3).

The operation of gun 35 would follow in sequence as follows:
1—depress trigger 34—generates laser beam pulse(s).
2—laser beam is routed through the probe optics 40, where it is concentrated and projected onto the sample 11.
3—energy which is re-radiated from the sample is collected through the same concentrator optics used to deliver the laser energy to the sample 11. It is routed through the probe optics 40 where it takes a parallel path (enabled by a dual function optic which serves as both a filter and a mirror), and enters into optical fiber 28.
4—collected energy propagates through the optical fiber 28 and is projected into the spectrometer 45.
5—processor 47 is activated, processes the spectral data and reports its results to the LCD back panel display 37. Alternatively the image may be fed to an output display such as computer 48.

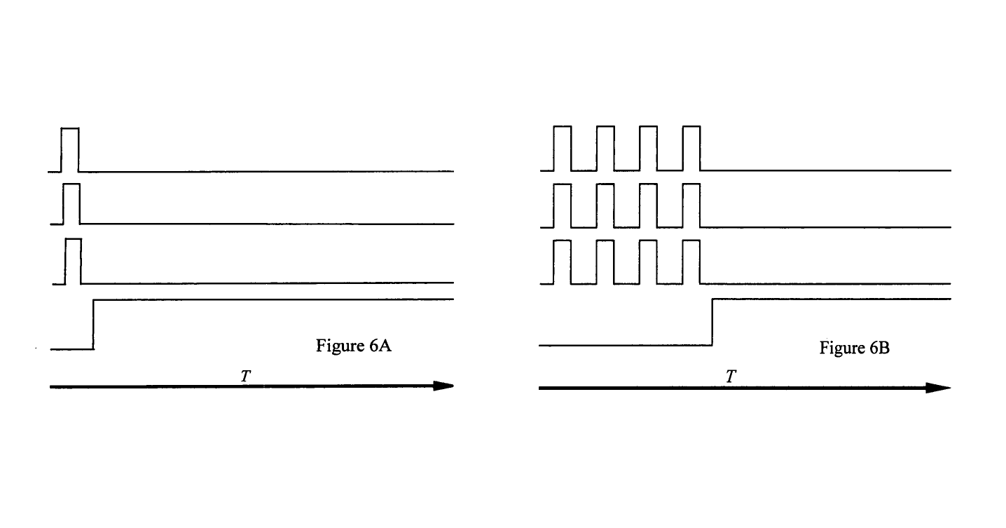

Referring now to FIGS. 6A and 6B, there are illustrated features that permit controlled exposure of samples, and effectively reduce both energy requirements and weight, facilitating portability while maintaining high sensitivity. In this Figure there is shown two embodiments (6A and 6B) of timing sequences. This embodiment incorporates pulsing of the laser beam, which provides a control over the amount of power that illuminates the sample. This is particularly important in the event that a sample is potentially explosive or cannot tolerate too much heat. In such cases the exposure to the laser beam can initially be at a short exposure and if it is determined that the sample can accept longer exposures, the length of exposure to the laser can be increased, or alternatively, the laser can be pulsed either through multiple triggering, or programming of the system to provide multiple exposures on a single triggereing of the system. It is also desirable to use a gating approach in the application of the high voltage applied to the detector. This can be done by effectively turning the photoresponse on and off so that it is only on when needed, reducing energy requirements for the system.

In FIG. 6A there is shown a timing sequence in which the detector or sensor 47 is activated to correspond to a triggering event. Thus, in this Figure, on the event of pulling the trigger of the gun, the laser beam is activated and illuminates the sample. This is shown in the top diagram in this Figure. The sample emits Raman signals and this is shown at the second level of this Figure. Simultaneously, the sensor is exposed to the Raman signal and this appears in the third diagram in this Figure. Finally in the lowest diagram, the Raman spectrum is being digitized. Time runs along the base line.

In FIG. 6B, there is shown a mechanism to control sample illumination. In this embodiment illumination is controlled by digitally setting the length of the pulse train. In the upper diagram, there is shown the output of the laser and in the second diagram is shown the emission of the Raman signal from the sample. In the third diagram in FIG. 6B, the sensor or detector is being exposed to the Raman signal.. In the next diagram the Raman spectrum is shown being digitized. Finally a time line appears at the base of FIG. 6B.

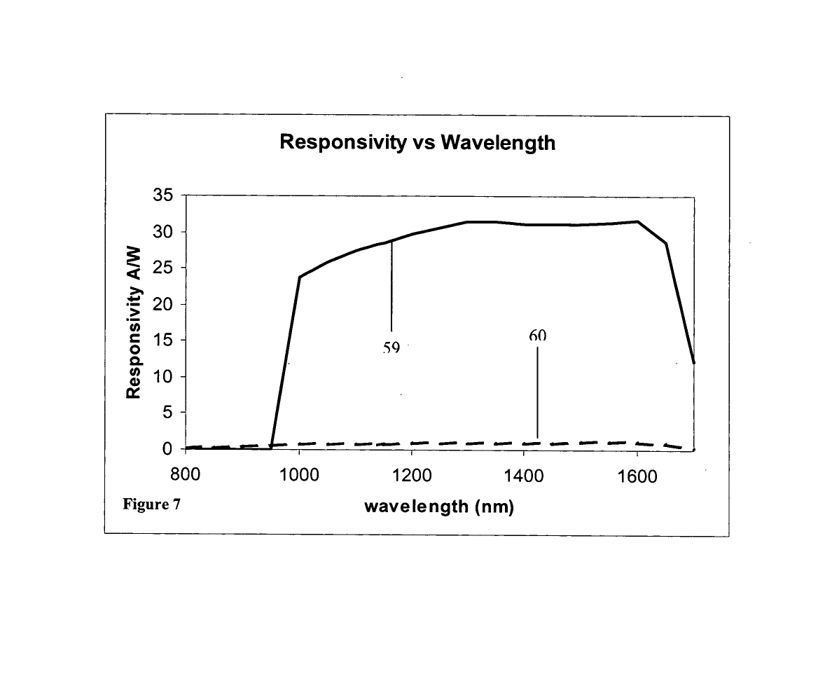

Reference is now had to FIG. 7. In this Figure there are two graphs shown. The graph identified as 60 shows the responsivity of devices that exist in the art in which InGaAs focal plane arrays are used. The curve identified as 59 shows the responsivity of CMOS focal plane array in a vacuum tube like arrangement in which the CMOS array is facing across a vacuum from a TE photocathode which may comprise an InGaAs layer. The CMOS in this arrangement is biased to attract released electrons from the photocathode. Responsivity curves are usually expressed in units of Ampere/Watts and is defined as the output in Amperes for each Watt of illumination across the active area of the pixel. These curves indicate the significant benefits in responsivity achieved when one uses electron bombardment in connection with a TE photocathode in Raman spectroscopy. The significant difference between these results is the gain achieved through electron bombardment as illustrated and discussed in connection with FIG. 5. It is noted that although a CMOS array has been mentioned as in this circuit, like results can be achieved with CCD's, CCD/CMOS hybrids and CCD's with on the chip gain, provided electron bombardment is used.

While responsivity is a very good indicator for a detectors sensitivity it is not a complete measure. Also significant are noise contributors and these must be included to calculate SNR (signal to noise ratio). TE-EB sensors and InGaAs focal plane arrays have a common equation for

$$SNR = \frac{( QE * S * G )}{\sqrt{( QE * S * D C ) * {G}^{2} * {F}^{2} + {RN}^{2}}}$$

$$QE = Quantum Efficiency ( \% )$$

$$S = Photon Flux ( photons \text{/} pixel \text{/} frame )$$

$$G = Gain Factor for EB or EM$$

$$F = Excessive Noise Factor$$

$$D C = Dark Charge of Photocathode$$

$$RN = Read Noise$$

Under light illumination levels typical for near-infrared Raman spectrometers, an apparatus employing a TE-EB detector can have as much as ×100 more SNR because of the Gain factor, G coupled with much lower noise factors for DC and RN relative to InGaAs focal plane arrays.

TE-EB detectors also have additional advantages for a near-infrared Raman spectrometer apparatus: As has been mentioned the TE-EB detector can be gated and that has several benefits. These are mentioned here because they also relate to signal to noise effects:
Fast gating <1 millisecond will lower the sensor dark charge for the exposure and that in turns lowers the sensor cooling requirement which in turn lowers the power budget for the apparatus
Sensor fast gating will reduce noise interference from background light and external sources because these contributions are at least directly proportional to the exposure time
The TE-EB sensor can be configured with a CMOS anode which will have several benefits for the near-infrared Raman apparatus:
   Smaller footprint for the detector and apparatus
   Lower power consumption for detector and apparatus.

Although this invention has been described with reference to particular embodiments and examples, other modifications and variations will occur to those skilled in the art in view of the above teachings and it is intended to encompass such variations within the scope of the appended claims.

What is claimed is

1. A Raman instrument comprising
a laser to generate light in the frequency range of 920 to 1700 nm,
said laser being positioned to direct its beam at a sample to be analyzed,
light gathering optics positioned to receive reflected Raman scatter and feed such scatter to a spectrometer,
a spectrometer to receive reflected scatter light and following treatment at a grating feed such light to a detector,
a detector including electron bombardment particularly sensitive to light in the wavelength range of 950 to 1700 nm to receive light from said spectrometer and produce an output image of said light for analysis, and
a display to report the identity of the elements of the sample.

2. A Raman instrument in accordance with claim 1 in which said detector includes a silicon focal plane array.

3. A Raman instrument in accordance with claim 1 in which said detector includes a transferred electron photocathode and in which said focal plane array of said detector is in a facing relationship with said transferred electron photocathode.

4. A Raman instrument in accordance with claim 3 in which said transferred electron photocathode and said focal plane array face each other across a vacuum.

5. A Raman instrument in accordance with claim 4 in which said focal plane array is biased at a high voltage in respect to said transferred electron photocathode.

6. A Raman instrument in accordance with claim 1 in which said laser generates light in the frequency range below about 1550 nm.

7. A Raman instrument in accordance with claim 1 housed in a casing shaped like a gun.

8. A Raman instrument in accordance with claim 1 in which said detector includes a CMOS sensor and in which said detector includes a transferred electron photocathode sensitive to radiation in the range of 950 to 1700 nm.

9. A Raman instrument in accordance with claim 8 in including a trigger to activate said laser.

10. A Raman instrument in accordance with claim 9 in which said laser is activated as a pulse, and in which a high voltage is applied to said sensor only during said pulse.

11. A Raman instrument in accordance with claim 7 in which said casing houses a laser that generates light in the frequency range of 950 to 1550 nm, and in which the Raman light scattered at said sample is gathered into said gun and fed to a CMOS array in said detector within said casing.

12. A Raman instrument in accordance with claim 5 in which said laser is activated as a series of pulses, and said high voltage is applied as pulses during the time said laser is activated.

13. A Raman instrument in accordance with claim 12 in which the Raman spectrum is digitized following said series of pulses.

14. A method of making Raman measurements of a sample comprising pulsing a laser operating at a near IR frequency at a sample, gathering scattered Raman reflected light from said sample and directing it to a silicon based focal plane array detector through a spectroscope, said detector comprising a TE photocathode and said silicon based focal plane array, receiving said light at said detector at said TE photocathode of said detector causing electron bombardment of said silicon based focal plane array, determining the elements of the sample using library matching of detected information of the sample, and displaying the chemical information determined by library matching.

15. A method in accordance with claim 14 in which said silicon based focal plane array comprises a CMOS sensor.

16. A method in accordance with claim 15 in which said CMOS sensor is biased to cause electrons released by said photocathode of said detector to bombard said CMOS sensor in said detector at time intervals corresponding to the time intervals said laser is pulsed.

17. A method in accordance with claim 15 comprising using an InGaAs semiconductor TE layer as a photocathode in said detector.

18. A method in accordance with claim 15 comprising using an InGaAsP semiconductor TE layer as a photocathode in said detector.

19. A method of improving responsivity in Raman spectroscopy comprising feeding gathered light from a sample to a TE photocathode in a detector, said detector comprising a TE photocathode positioned in facing relationship to a CMOS array across a vacuum, applying a bias to said CMOS array relative to said TE photocathode causing electron bombardment of said CMOS array conforming to the incoming light patterns.

20. A method in accordance with claim 19 including pulsing a laser to illuminate the sample and pulsing said CMOS array simultaneously.
